(19) United States
(12) Patent Application Publication
(10) Pub. No.: US 2009/0228299 A1
(43) Pub. Date: Sep. 10, 2009

(54) METHODS AND APPARATUS FOR CONTEXT-SENSITIVE TELEMEDICINE

(75) Inventors: Hooshang Kangarloo, Pacific Palisades, CA (US); Usha Sinha, San Diego, CA (US); Ricky Taira, Newcastle, WA (US); Alexander Bui, Los Angeles, CA (US)

Correspondence Address: KNOBBE MARTENS OLSON & BEAR LLP, 2040 MAIN STREET, FOURTEENTH FLOOR, IRVINE, CA, 92614, US

(73) Assignee: The Regents of the University of California, Oakland, CA (US)

(21) Appl. No.: 12/092,687

(22) PCT Filed: Nov. 9, 2006
(86) PCT No.: PCT/US06/44017

§ 371 Date: Oct. 29, 2008

Related U.S. Application Data
(60) Provisional application No. 60/735,083, filed on Nov. 9, 2005.

(51) Int. Cl. G06Q 50/00; G06F 17/30; G06F 17/27

(52) U.S. Cl. 705/2; 707/5; 704/9; 707/E17.017; 707/E17.02; 707/E17.044

(57) ABSTRACT

A system for context-sensitive medical communication is described. Patient presentation data is obtained, the patient presentation data is mapped to biological system data, wherein the biological system data are obtained by a population-based comparison, and a relevance-driven summary is generated. Following the primary read, the study can be compressed and transmitted remotely, such as in teleconsultation described below. The imaging study can be provided by patient presentation mapping to medical nomenclature, and mapping the patient study to an appropriate normalized atlas which has been created by averaging and morphing as well as quantification and providing labels which have come from data mining of reports.

### REFERENCE TO RELATED APPLICATIONS

The present application claims priority to U.S. Provisional Application No. 60/735,083, filed Nov. 9, 2005, titled “METHODS AND SYSTEMS FOR CONTEXT-SENSITIVE TELEMEDICINE CROSS-REFERENCE TO RELATED APPLICATIONS,” the entire contents of which is hereby incorporated by reference.

### STATEMENT REGARDING FEDERALLY SPONSORED RESEARCH OR DEVELOPMENT

The invention was made in part with Government support under National Institutes of Health Grant EB02247. The Government has certain rights in the invention.

### BACKGROUND OF THE INVENTION

1. Field of the Invention

The present teachings relate to methods, systems, and articles of manufacture for automatically selecting and communicating medical information.

2. Introduction

Advances in medical imaging have been associated with increased complexity and volume of data (e.g., multi-slice CT, MRI, etc.), and thus, require management techniques to improve the efficiency of communication in such studies. Previous studies are often required for comparison, particularly for patients with chronic and complicated conditions (e.g., cancer, musculoskeletal pain, etc.), adding to the volume of medical data to be reviewed by a consultant. Viewing image-intensive studies during medical communication or incorporating them in their entirety into the medical record for review by primary care physicians, patients, or multiple consultants (e.g., oncologists, surgeons, radiologists) can be cumbersome, costly, and impractical.

Previous research on the use of medical images in medical settings has focused on image compression. These methods do not address medical communication efficiency or effective documentation/communication among healthcare stakeholders (including primary care physicians and patients), such as presenting the most relevant findings in an imaging-based diagnostic workup. Consequently, medical communication is often performed without sufficient clinical context, prior studies, or the medical hypotheses from the primary healthcare provider. Subspecialty medical communication is, thus, time-consuming and can be underutilized, potentially reducing the quality of care. Furthermore, imaging-based medical communication is not effectively incorporated into the patient's medical record and routine practice.

The extreme breadth and depth of current medical knowledge, and the speed with which it advances, is beyond the ability of any single physician to assimilate and acquire. Thus, no single physician can be sufficiently prepared to deal with all possible medical conditions at all possible levels of severity. Medical specialization or super-specialization is a consequence of this reality; however, super-specialists tend to be concentrated within relatively small geographical regions, mostly in academic and specialty medical institutions. The net result of this situation is that many patients and physicians typically do not have practical access to the most appropriate specialist for a given medical condition, even though there is documented evidence in the literature that medical communication among appropriate specialists does improve the quality of care and accuracy of interpretations.

Most of the technical advances in medical communication have been data—or event-driven, and not context-sensitive. For example, current telemedicine technology typically focuses on the acquisition, transmission, and archiving of medical data, and not necessarily the purpose or role of this data in the process of care. Thus, for conventional telemedicine technology, much energy has been devoted to image compression. Approaches range from lossless to lossy, but all take a global, black-box view of medical image data and compress the entire study as a monolithic package of information. Because lossy compression algorithms do not exactly reproduce the original medical images, they need to be validated as being of diagnostic quality. Alternatively, hybrid lossless/lossy algorithms have been proposed, so that “important” regions do not lose data. However, in such algorithms, the entire study remains as the object being compressed, reflecting the view that images are blocks of data to be processed, as opposed to information that can be clinically summarized. Approaches other than compression exist, taking greater consideration of the context of telemedicine. However, the context remains architectural rather than task-based, including such alternatives as pre-fetching or integration into an existing Picture Archiving and Communication system (PACS).

Event-driven perspectives of medical communication have led to emphases on videoconferencing and pure bandwidth or on real-time interactivity for a single event, such as a surgical procedure. For example, related conventional work on telemedicine seems to imply that the hurdle toward wide acceptance is purely technological in nature, waiting only for sufficient security, bandwidth, and information processing needs to be fulfilled.

These conventional models serve well in exploratory settings, but do not serve specific clinical tasks where clinical context is just as crucial as overall knowledge. Their manual construction results in a one-size-fits-all anatomy, overlooking variations based on the individual, current case or medical condition. Many conventional coimunercial diagnostic workstations include features that permit physicians to provide some context by manually selecting key images from a study. As in any manual procedure, this action impacts the physician or scientist's time and is not practical to use routinely as part of clinical practice. In addition, and perhaps more importantly, such a manual system can only index on a specific attribute defined by the interpreter at that time and thus, cannot support a range of queries.

### SUMMARY OF THE INVENTION

These and other problems are solved by a system for context-sensitive medical communication. In one embodiment, context-sensitive patient data, including obtaining patient presentation data, is mapped to biological system data, wherein the biological system data are obtained by a population-based comparison, and generating a relevance-driven summary. In one embodiment, the relevance driven summary is tailored to a set of user-defined inputs is provided.

In one embodiment, the system includes facilities for obtaining a patient presentation; mapping the patient presentation to a standard nomenclature; generating a list of relevant anatomical structures based on the patient presentation; delineate known anatomical structures; generating a relevance-driven summary by combining relevant structures and delineated contours; and transmitting the summary to a remote location via a network.

One embodiment includes a method for context-sensitive medical communication which includes: obtaining a patient presentation, mapping the patient presentation to a standard nomenclature, generating a list of relevant anatomical structures based on the patient presentation; delineating known anatomical structures, generating a relevance-driven summary by combining relevant structures and delineated contours, and transmitting the summary to a remote location via a network.

In one embodiment, a data processing system is configured to obtain a patient presentation, map the patient presentation to a standard nomenclature, generate a list of relevant anatomical structures based on the patient presentation, delineate known anatomical structures; and generate a relevance-driven summary by combining relevant structures and delineated contours, and transmits the summary to a remote location via a network. In yet another embodiment, a method is provided for producing a normalized anatomical atlas, including comparing and summarizing image data of multiple normal subjects, and labeling the summarized image data with labels derived from data mining of imaging reports using natural language processing. Also provided is a normalized anatomical atlas produced by such method.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1 shows a medical communication system.

FIG. 2 is a schematic of the architecture for the corpus-driven anatomy knowledge base.

FIG. 3 shows one embodiment of a diagnostic imaging profile.

FIG. 4 shows anatomical structure delineation.

FIG. 5a shows example diffusion weighted echo planar images wherein visual match of the contours superimposed on the warped images confirms that the local formation algorithm corrects for distortions.

FIG. 5b shows example diffusion weighted echo planar images wherein the corrected images show good alignment with the anatomical T2 images as confirmed by the superimposed contours.

FIG. 6 shows one embodiment of networked computers for use with the system.

FIG. 7 shows one embodiment of a summarizer computer.

### DETAILED DESCRIPTION

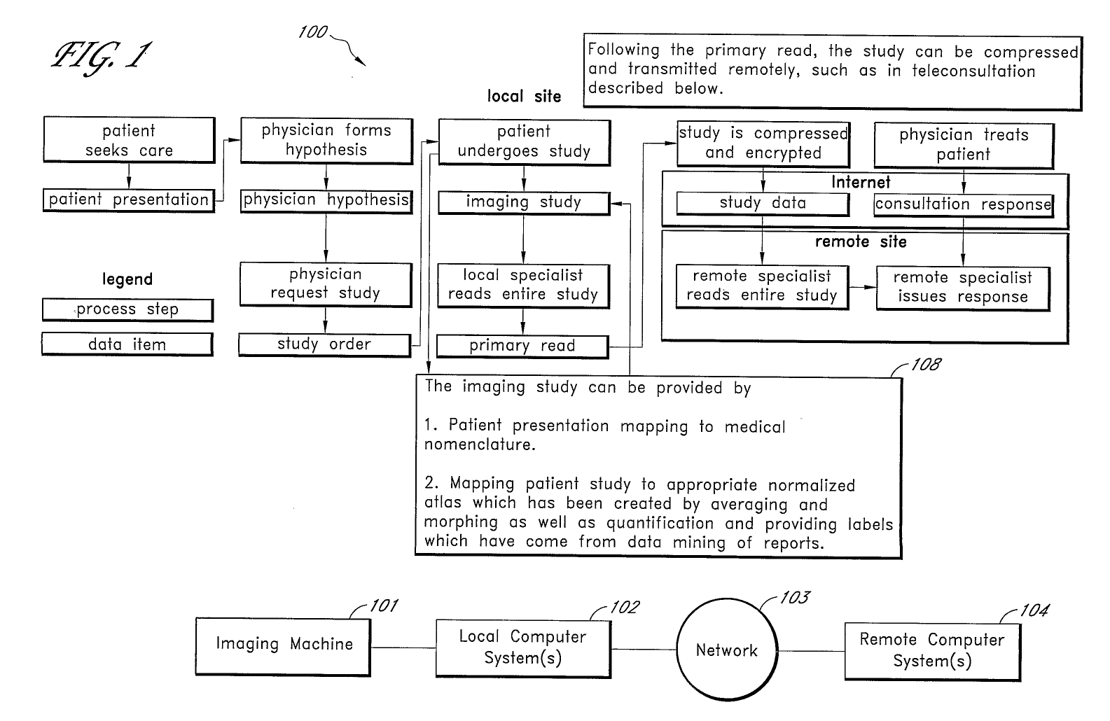

FIG. 1 shows a context-sensitive medical communication system 100, including physician/physician, physician/patient communication, and telemedicine. In the system 100, a patient seeking care provides patient presentation data (e.g., a description of the symptoms) to a physician. The physician forms hypothesis, requests an imaging study. In the imaging study, a medical imaging device 101 (e.g., a MRI, CAT-scan, PET scan, etc.) is used to create images of the patient. An image summarizer 108 running on a computer 102 is used to process the images with a knowledge base to produce the imaging study. The imaging study includes a relevance-driven summary. The imaging study (including the summary) can be provided to local specialists. The image study (including the summary) can also be provided to remote specialists via a computer network 103 such as, for example, the Internet. Thus, the system 100 provides patient presentation data, mapping the patient presentation data to biological system data, wherein the biological system data are obtained by a population-based comparison, and generating a relevance-driven summary. The relevance driven summary can be tailored to a set of user-defined inputs.

The system 100 expands the utility of medical communication among physicians to include patients and other healthcare providers. Anatomy modeling, which involves capturing, in static form, the structures of the human body in increasing detail, can be useful in such visualization; results can include user interfaces for browsing anatomical structures visually, with mappings to medical images or contours. Containment relationships (part-of) can be emphasized, which can include other relationships such as classification (kind-of), connectivity (tributary-of), and function (performs). Many knowledge bases can also provide for mapping to standardized codes, facilitating interoperability and sharing. It will be understood by one of skill in the art that medical visualization, including the visualization of biological system data, particularly biological system data are obtained by a population-based comparison, can encompass technologies known in the art.

Medical communication technology coupled with the Worldwide Web can provide patients and their physicians with unprecedented access to their complete medical record. Thus, context-sensitive medical communication can transform patient-physician relationships. The system 100 can provide medical information in full detail or subjected to data distillation or summarization to achieve appropriate patient focus.

Beyond individual patients, the system 100 can be utilized for public health applications. In addition to the ability to summarize data, intelligent de-identification technology can be utilized in the present invention in order to protect individual patient identities while not depriving public health workers of the collective medical data.

In one embodiment, the system 100 provides patient presentation; mapping the patient presentation to a standard nomenclature; generating a list of relevant anatomical structures based on the patient presentation; delineate known anatomical structures; generate a relevance-driven summary by combining relevant structures and delineated contours; and transmitting the summary to a remote location via a network.

In one embodiment, the computer 102 includes a memory having a program that obtains a patient presentation, maps the patient presentation to a standard nomenclature, generates a list of relevant anatomical structures based on the patient presentation, delineates known anatomical structures; generates a relevance-driven summary by combining relevant structures and delineated contours, and transmits the summary to a remote location via a network; and a processing unit that runs the program.

Imaging studies, such as those obtained using magnetic resonance imaging, typically contain a large number of image slices. The automated, intelligent imaging summarizer 108 chooses relevant image slices and transmits the slices to remote locations via a network, such as the Internet. Images can be transmitted in an uncompressed format, allowing no information loss due to compression.

The image summarizer 108 can include, but is not limited to, functionality for image routing (e.g., using eXtensible Markup Language (“XML”)); statistical language processing that creates a corpus-based NLP-guided knowledge base; diagnostic image mapping that specifies image sequences that best depict a region of interest (either structure containing the abnormality or confirming the normal); and anatomic structure delineation using an atlas selector which in turn uses customizable reference atlases, a registration module, and a contour generator module. The summarizer 108 can further include natural language processing for knowledge-based creation.

The system 100 can provide context-sensitive medical communication by automatically identifying the most relevant image slices containing anatomical structures of interest, which can be achieved by combining a corpus-based anatomy knowledge base with structure delineation through image registration, deformation, and atlas mapping. One of skill in the art will recognize that such anatomical information can include biological system data, particularly biological system data obtained by a population-based comparison. Biological systems can include a coronary system, vascular system, gastrointestinal system hepatic system, skeletal system, nervous system, and the like which can be found throughout a patient. To make higher-quality and more efficient medical communication routinely possible, the image summarizer 108 can automatically identify relevant anatomical structures and appropriate imaging sequences for a given patient presentation, and automatically locate relevant anatomical structures in the appropriate imaging sequences within a patient imaging study.

The system 100 can provide corpus based methods using statistical natural language processing (NLP) methods to acquire a model of presentation-to-condition and/or presentation-to-anatomy correlations. Image registration (moment based, intensity-based affine) and deformation (optical flow) algorithms can map patient studies to a customizable labeled atlas. A teleconsultation can include (1) automatically summarized imaging data, (2) accurately-reported patient presentation, and (3) specific clinical questions based on a caregiver's initial hypotheses, and thus (a) the teleconsultation is more efficient and (b) teleconsultation quality is improved.

The system can also be evaluated technically two ways: (a) a technical evaluation can be performed in the development environment to assess whether automated techniques are performing to task, and (b) a clinical evaluation can test the experimental system in a real-world environment. Technical measures include recall and precision metrics for relevant structure selection and structure delineation, both as compared to experts. Clinical evaluation can, for example, be a stratified, two-arm study and can measure time required for medical communication and diagnostic accuracy as determined by an expert panel.

In one embodiment, the system 100 is configured for producing a normalized anatomical atlas, including comparing and summarizing image data of multiple normal subjects, and labeling the summarized image data with labels derived from data mining of imaging reports using natural language processing. Also provided is a normalized anatomical atlas produced by such method. This method and the atlas can be used in the methods above to enhance medical communication among physicians and between physician and patient. Because the amount of medical information can be reduced by performing this method and utilizing the atlas, the relevant medical information is targeted to the patient presentation and its availability enhanced for other physicians and the patient to utilize.

The context-sensitive medical communication infrastructure can be based on structuring medical reports and text and identifying key image slice(s) from a large imaging set.

The input of an NLP system can be a free text medical report; its output is a set of structured frames, each frame containing a topic (e.g., lymphadenopathy), and a set of property descriptions (e.g., existence, location, size, severity).

In one embodiment, the NLP system provides section boundary detection. The input is a free-text medical report and outputs include the start/end byte offsets and type of each section within the report (e.g., header, procedure description, findings, conclusion). A reliable rule-based algorithm (i.e., rules that are ˜100% always true) is employed to detect obvious starts to new sections using a knowledge base of commonly employed heading labels (e.g., findings, history, impressions) and linguistic cues (e.g., colons, all capitals), as observed within a collection of training examples. Second, the algorithm handles the detection of section boundaries that do not have predictable markers using a probabilistic classifier based on an expectation model for the document structure.

The next operation is the identification of sentence boundaries within each section of report text. In one embodiment, the algorithm for determining sentence boundaries uses a maximum entropy classifier (as described, for example, in Maximum Entropy Models For Natural Language Ambiguity Resolution. Ratnaparkhi A., PhD dissertation, Dept. of Computer and Information Science, University of Pennsylvania, 1998, hereby incorporated by reference). In one example embodiment, the classifier uses 44 overlapping features to determine end-of-sentence markers, with recall and precision currently both over 99.8%.

The input to the lexical analyzer is typically a sentence. The output includes word tokens tagged with semantic and syntactic classes. Aspects of one implementation include: (1) a large number of semantic classes (>250) as compared to currently available lexical sources (e.g., UMLS), improving discrimination for parsing, semantic interpretation, and frame building tasks; (2) recognition of a variety of special symbols including dates, medical abbreviations (e.g., T1 for “thoracic spine one”), medical coding symbols (e.g., “TNM” lung cancer stage), numeric measurements, image slice references, and proper names (e.g., patient names); (3) some word sense disambiguation (e.g., density as a finding vs. a property) using surrounding syntactic and semantic word features; and (4) over 120,000 radiology reports have been processed thus far, resulting in over 35,000 mostly word-level entries.

Phrasal chunking involves identifying logically coherent, non-overlapping sequences of words within a sentence, reducing the dimensionality of the overall NLP task (as described, for example, in Text Chunking Based On A Generalization Of Winnow, Zhang T, Damerau F, Johnson D., J Machine Learning Research. 2002; 2:615-637., hereby incorporated by reference). In one embodiment, common phrasal units in medical text are targeted: anatomic phrases (e.g., right upper lobe of lung); finding expressions (e.g., focus of increased density); anatomy perturbation expressions (e.g., elevation of the diaphragm); existential relations (e.g., there is no sign of); spatial relations (e.g., extending 5 cm above); and causal/inferential relations (e.g., is consistent with that of). Phrase definition includes complex phrases such as “the superior aspect of the mid pole of the right kidney” as well as compounds like “the left upper lobe and the right upper lobe.” The phlase chunking problem can be stated as: given a phrase type, tag each word in the sentence as a beginning, ending, inside, single, or outside word token, as shown in Table 1 below. Classifier development follows a supervised learning approach using a training corpus of over 10,000 examples from each phrasal category and a rich feature set including n-gram word statistics, syntactic parser output, and semantic constraints. Features are integrated and weighted into a single statistical model using a maximum entropy classifier.

TABLE 1

| | Words: | | | | | | | |
|---|---|---|---|---|---|---|---|---|
| | There | is | a | right | upper | lobe | mass | seen |
| Tags: | outside | outside | outside | begin | inside | end | outside | outside |

In one embodiment, the NLP system combines syntactic parsing and semantic interpretation to understand word-word relationships within a sentence.

In one example embodiment, a set of relations has been defined for the representation of logical relations between concepts seen in medical reports. Many types of predicate relations can be defined, such as, for example, hasLocation, hasSize, hasExistence, hasCauseEffectRelation, and hasInterpretation.

Typically, a separate classifier is developed for each type of logical relation. Thus, the logical relation hasArticle classifier is designed separately from that of hasSize. Separating classifiers has three advantages: (1) significantly reducing the solution space of each classifier (e.g., there are a limited number of ways one can describe the size of an object); (2) allowing only features significant for discriminating the presence of a logical relation instance to be captured within the specific classifier; and (3) allowing collection of a large number of training examples for any logical relation type, regardless of the relative frequency of the relation in real-world corpora (e.g., though the prevalence of the hasArticle logical relations is greater than say, hasSize, sufficient hasSize examples can be simply obtained by retrieving over a larger corpus).

Most conventional medical NLP systems use symbolic methods (e.g., rule-based) for classifier implementation. In one embodiment, the NLP system used in the system 100 can be based on statistical methods (e.g., maximum entropy model), facilitating adaptability to new domains.

In one embodiment, global minimization of parsing operations is provided. The probabilities of word-word attachments over the entire sentence can be globally maximized using a simulated annealing algorithm which considers all alternative semantic interpretations for word-word semantic pairing within a sentence.

Given a set of logical relations, the next step outputs structured frames. The slot types for a target frame representation are identified using corpus-based methods. The approach includes four stages: (a) Mining of a list of all unique logical relation instances identified from the parser/semantic interpreter stage for a large body of medical reports; (b) For each unique instance, apply a concept relaxation operation to the head, relation, and value of the logical relation instance. Operations include: relaxing words to a parent concept (e.g., mass→.lesion); relaxing a head word to a semantic or syntactic class (e.g., mass→.physobj.abnormal.condition, mass→.noun); or no relaxation. The degree of relaxation is controlled by how specificity of a particular property (e.g., size) should be modeled to a particular type of object, and is manually assigned by an expert. For example, size can be generalized as a property of any solid physical object, whereas calcification patterns can only be applicable to a subclass of objects such as lesions. (c) A new histogram of unique relaxed logical relation instances is compiled for the corpus. (d) For each relaxed logical relation instance, a set of instructions is defined for frame building. For example, an instruction can indicate to attach word A to word B via the predicate (hasSize).

The NLP process described here determines associations among concepts by examining the co-occurrence of frames within a corpus of medical documents. Moreover, passages of medical reports can be mapped to a standardized nomenclature derived from UMLS. This can be extended to use NLP-generated frames rather than passages of raw text derived from medical reports, as explained below.

In one embodiment, relevant image slice selection is provided. A delineator includes contrast-customizable atlases that can be synthesized from T1, T2, and proton density weighted parametric images acquired in normal subjects in different age groups. Image slice selection can include three distinct stages: study identification, registration, and contour generation.

The Digital Imaging and Communications in Medicine (DICOM) headers of the images are read in a study identifier module, which provides information related to each series in the study, including: the imaging plane (axial, coronal, sagittal, or oblique); the sequence type (2D or 3D); the slice thickness; the slice spacing; the number of slices; and the echo time (TE) and repetition time (TR). The module preferentially uses 3D patient data sets for atlas registration because of higher spatial resolution.

The image series chosen by the study identifier module is used as the target image set for registration against a reference image set, a labeled brain atlas.

The illustrative brain atlas used was derived from an averaged high contrast template based on three-dimensional volume data (256×256 matrix, T1-weighted, SPGR sequence) from nine subjects. In one embodiment, 68 structures have been defined as 3D contours in the stereotactic coordinates of this template. The coordinates were projected on a slice-by-slice basis to facilitate ready identification of the atlas slices containing different anatomical structures. Image plane information was used to re-slice atlas images along image scan planes (e.g., the brain atlas was re-sliced along the axial planes to register a set of axially acquired images).

In one embodiment, the registration algorithm used is the open-source Automated Image Registration (AIR) program. The algorithm used is based on a voxel intensity matching and has been tested extensively for accuracy using both inter-subject and intra-subject registration. The spatial transformation model used is the twelve parameter 3D affine linear model, which has been validated in previous inter-subject MR studies as optimal in terms of accuracy of registration and computation time.

The contour generator module takes as input the spatial transformation matrix produced by the registration algorithm to transform the coordinates of structures defined in the atlas space to coordinates within the patient image dataset. After the transformation, the coordinates are projected on a slice-by-slice basis (x-y coordinates collated at the same z-value) to facilitate identification of the patient slices containing different anatomical structures.

Image study summarization automatically identifies the relevant images, defined as the images of the study that contain the structures of interest associated with findings in medical reports (e.g., radiology reports). A natural language processing module structures the free text reports and the output of the NLP drives the image summarization module to select the structures of relevance to the study.

In this approach, image summarization can take place after the imaging study has gone through a primary read. Thus, the anatomy knowledge base can be used to provide the information needed for summarization before the study is seen by the local specialist.

In one embodiment, a medical communication infrastructure has been implemented between UCLA and Melbourne, Fla. The system uses an Internet-ready image routing system that uses XML (eXtensible Markup Language) rules to determine study destination and adopts open standards for compression and encryption. To fulfill the overall data needs brought on by the importance of clinical context, a distributed information system (hereinafter referred to as a “DataServer”) is used. The DataServer links multiple autonomous medical repositories and accommodates industry-standard security and privacy protocols as well as a healthcare-specific mechanism for patient record de-identification. It can also store and retrieve medical images in the standard DICOM protocol and format.

While the DataServer manages the back-end component of medical information (storing, filtering, and retrieving data) a timeline module presents this information in a rich but manageable timeline format. The timeline module displays comprehensive patient history from a DataServer site using a visual, chronological metaphor. Like the DataServer, the timeline module can handle DICOM images, and so can display imaging as well as alphanumeric data in an integrated manner.

In the system 100, initial physician hypotheses are formulated by the primary healthcare provider (PHP). The local specialist is a consultant to the PHP (e.g., local cardiologist or radiologist, etc.). The remote specialist is a second-tier consultant (e.g., pediatric urologist, etc.). As described herein, the model can be substantially improved by incorporating the atlas development and patient mapping processes related to providing the imaging study.

The context-sensitive medical communication infrastructure automatically identifies sentinel images from imaging studies based on initial patient presentation and the referring physician's medical hypothesis. The system provides clinical context with (1) the patient presentation, (2) physician hypothesis, and (3) automatically-generated summaries of prior studies. The image summarization module 108 includes (a) an anatomy knowledge base constructed from a corpus of medical reports that correlates symptoms, medical conditions, and anatomical structures, and (b) a customizable, labeled image atlas that identifies anatomical structures within a given imaging study. As MR is perhaps the most valuable routinely used imaging modality for the evaluation of neurological and musculoskeletal disorders, the test bed for these innovations emphasizes this modality. To assist non-specialist users (e.g., primary care physicians, nurses, and patients), a diagnostic imaging profile will be provided to correlate functions and symptoms (patient presentation) with anatomical imaging studies.

By extending medical communication technology outward from data transmission alone toward providing clinical context and summarized, relevant information, the efficiency and quality of medical communication is improved and the summarized medical communication results are readily incorporated into the patient EMR, viewable by other healthcare providers and thus facilitating further improvements in other areas, such as continuity of care.

The medical communication process described herein can be focused on interaction among (1) patients (capturing, structuring, and standardizing patient presentation), (2) a local healthcare provider (capturing, structuring, and standardizing initial hypotheses), (3) imaging to objectively document a medical condition (including local specialist interpretation and normal/negative studies) and (4) remote specialists. In addition to improving medical communication efficiency and incorporating this information into the individual patient EMR, the system collects patient presentation, initial physician hypotheses, medical reports, and the most relevant image slices routinely from a real-world environment and making them available, after de-identification, for future data mining and population-based research. Medical communication in complicated cases gene rally requires imaging and, by definition, these cases would be ideal for various forms of outcomes analysis.

Methods, systems, and articles of manufacture consistent with the present invention can address the above four interactions and provide a unique medical communication infrastructure for clinical practice and research, including: (a) a corpus based, NLP-guided knowledge base, and (b) automated, atlas-guided delineation of anatomical structures in a given imaging study.

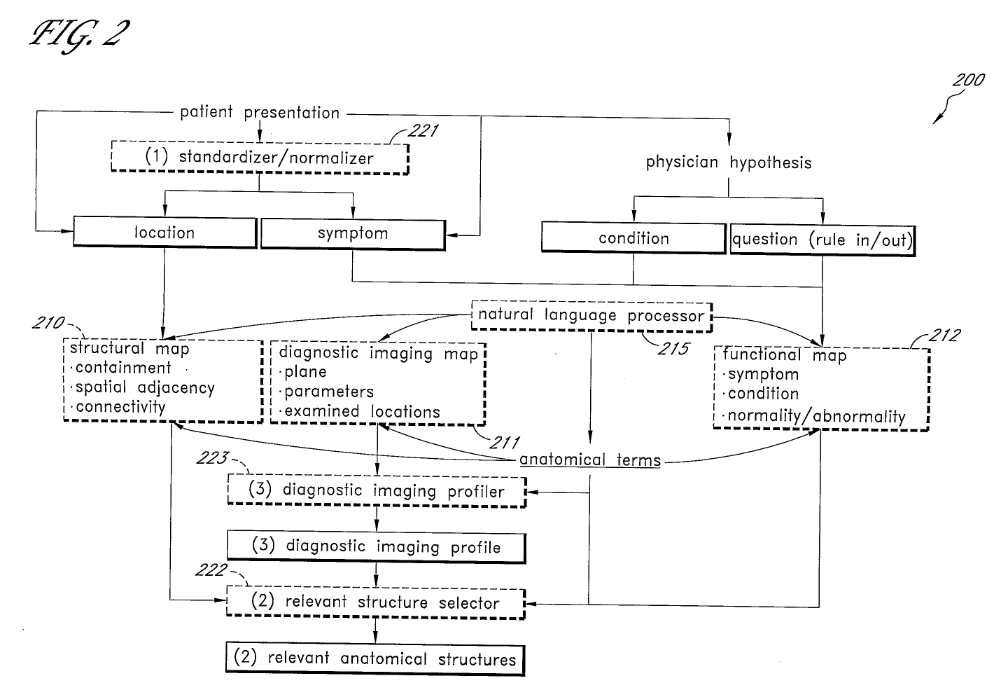

A knowledge base grounded in an existing corpus of medical reports is used by the image summarizer 108 to provide context-sensitive medical communication. The knowledge base is constructed using statistical NLP. Once constructed, the knowledge base can then be used as shown in FIG. 2 for: (1) standardizing and normalizing free-form patient presentation for use as input for relevant structure selection and diagnostic image profiling; (2) correlating this standardized patient presentation to possible medical conditions and anatomical structures of interest (i.e., relevant structure selection); and (3) correlating the current patient case with the imaging sequence that best visualizes these anatomical structures (i.e., diagnostic image profiling).

FIG. 2 is a schematic of the architecture for the corpus-driven anatomy knowledge base 200 used by the image classifier 108. The major components of the anatomy knowledge base are the master set of known anatomical terms and three probabilistic correlation maps for these terms: structural, functional, and diagnostic imaging. The structural and functional maps are used for tasks (1) and (2); in task (1), they are used to convert the incoming patient presentation into a standardized location+symptom pair. In task (2), they assist in inferring relevant structures from this standardized presentation. Finally, task (3) takes the patient presentation and infers the appropriate imaging sequences for it, using the knowledge base's diagnostic imaging map.

The system gathers the overall set of terms from the tagged natural language processing output of a selected report corpus. In an illustrative example, two corpora can be used, one each for the neurological and musculoskeletal domains.

A knowledge base can not only include the concepts within a given topic (e.g., anatomy, chief complaints, physician hypotheses), but can also provide a comprehensive list of how real users (patients, physicians) express these concepts. Real world expressions of patient chief complaints and physician hypotheses are extracted from a large corpus of medical reports from each given target domain. This can be performed as follows:
Gather a large corpus of medical reports from each target domain (i.e., neurology, musculoskeletal).
For each report, apply a semantic phrase chunker that automatically locates logically semantically coherent phrases. In one embodiment, the phrase chunker targets anatomy expressions, spatial relations, and abnormal conditions/findings. The term “phrase” can include complex expressions such as “lateral inferior-aspect of medial meniscus” as well as compounds (e.g., “left upper lobe and the right upper lobe”).
Process reports within the corpus, compiling a histogram of unique plrases. For example, in one embodiment, the phrase chunker, identified 8,270 unique anatomy expressions from a corpus of 6,418 radiology reports. For many findings and/or abnormal condition terms, there can be implied anatomy definitions built into the term itself. For example, visual field problems imply involvement of the optic nerves and optic chiasm. This information can be obtained through specification by a medical expert or by consulting the topology axes of SNOMED-CT.

The system automatically captures patient presentation (chief complaint, including signs and symptoms, if provided) and physician hypotheses as a mandatory field before a request for imaging studies can be processed. The system uses these requests to parse patient presentation and physician hypotheses and map them to a standard nomenclature (UMLS or SNOMED-CT). Unmatched terms are added directly to the knowledge base lexicon. In one embodiment, the statistical NLP captures both positive and negative findings. For example, when patient presentation and initial physician hypotheses are non-specific (e.g., presentation of “car accident,” hypothesis of “rule out internal injury”), the imaging report (e.g., “no evidence of meniscal tear or brain lesion is identified”) aids in enhancing the knowledge base (i.e., “look for meniscal tear after accident in . . . ”. These expressions can be manually validated by a human expert (i.e., physician).

The collection of words and phrases from actual reports and patient presentations ensures that the system works at a practical level and that most of the string representations for the concepts within the knowledge base are included. The master list of terms varies in size depending on the corpus. These terms are correlated either according to structural, functional, or diagnostic imaging criteria, represented as maps that link the master list of terms to other terms.

The structural map encodes how anatomical terms relate to each other physically within the body. Various types of correlation can be identified, including, but not limited to: containment, spatial adjacency, and connectivity. The location component of the patient presentation is sent to the structural map to produce a set of structurally related anatomical terms.

Containment indicates the compositional relationships of anatomical terms—which term contains which. Humans tend to visualize containment in a hierarchical fashion, with terms representing substructures clustered underneath terms representing the composite structure. Depending on performance and scalability, this hierarchy can carry over to the actual computer representation of anatomical containment. However, alternatives do exist, including statistical tables and semantic networks. The aim is to determine relatively quickly and relatively accurately, for a given anatomical term: (1) the structures that this term contains, and (2) the structures that contain this term.

Spatial adjacency refers to the positional relationships of anatomical terms—which structures are physically near another one in the human body. Approaches to capturing spatial relationships run the gamut from full geometric modeling (3D contours, meshes) to pictorial indices (quadtrees, octrees) to explicit, comprehensive labeling of term pairs. In an example, a grounding approach is used, where anatomical terms are associated with a single vertex within a selected 3D image. Using a single vertex instead of a contour or volume, Euclidean distance between such vertices provides a straightforward measure of spatial adjacency that is sufficient for context-sensitive medical communication. Using these approaches, the system can quickly and accurately identify the structures that are physically adjacent to or near another given structure.

Connectivity is associated with how anatomical structures physically interact with other structures. For example, the brain and the nerves at the extremities exhibit a connectivity relationship even though neither structure contains the other and they are not physically close to each other. Nevertheless, connectivity is a significant factor when determining how anatomical structures affect each other. The system uses connectivity in order to improve the speed and accuracy in identifying how other anatomical structures can interact with a given term.

Information sources for the structural map 210 are readily available, in terms of anatomy texts, diagrams, ontologies (e.g., UMLS), and an imaging atlas. Terms identified by the NLP 215 in the report corpus can be mapped to locations within these sources. The mapping allows anatomy sites defined by such authoritative sources to be indexed directly by terms used in actual clinical practice. Stop-word filtering and stemming can be performed to generalize and reduce the size of the knowledge base without compromising retrieval recall and precision.

The functional map relates bodily function to anatomical terms. Function is expressed in three ways: (1) symptom, (2) condition, and (3) normality. The symptom component of patient presentation, as well as the entire physician hypothesis, is sent to the functional map to produce a set of functionally related anatomical terms.

Symptom mapping includes identifying the anatomical terms that can exhibit a given symptom. Certain symptoms, such as “pain,” are quite generic and therefore do not answer these questions precisely. The system handles such generic symptoms without ignoring them completely. For example, “pain” can be correlated with the patient-presented location after it has passed through the structural map. When combined with a more specific set of anatomical structures, the generic “pain” symptom can be translated into other symptoms of greater specificity.

Condition mapping includes identifying the anatomical terms that can be affected by a given condition. A particular challenge for this mapping includes systemic conditions such as diabetes, which can affect a significant portion of the human body. By staying within the neurological and musculoskeletal domains in this proposal, the system can address the most common cases for which MRI exams are requested while gaining additional knowledge that can eventually be applied to an effective approach for handling systemic conditions.

Normality differs somewhat from symptom and condition mapping, in that normality is actually a modifier on the symptom and condition instead of being a relatively more direct link to related terms. When the physician's hypothesis involves ruling out a particular condition, normality is sought in relation to that condition, and this sometimes produces a different set of anatomical terms from when the physician question is to verify the existence of that condition.

In one example, a functional map is built from statistical analysis of the same report corpus that produced the master list of anatomical terms. This analysis focuses on co-occurrence among symptom, condition, and anatomical terms within different groupings of the corpus: individual reports, individual patients, findings, and conclusions. Probabilistic tables are accessible by symptom or condition, modified by normality.

The diagnostic imaging map 211 specifies the imaging sequence that best shows the region of interest (either the structure(s) containing the abnormality or the structure(s) confirming normalcy). The attributes of the imaging sequence include (1) sequence type (SE, GE, FLAIR, fat suppressed), (2) imaging condition (post-contrast, dynamic perfusion), and (3) image orientation (sagittal, transverse/axial, coronal). These attributes define the image sequence that is best for visualizing the condition.

To further assist healthcare providers—particularly those not specialized in imaging (e.g., family medicine) and non-physicians (e.g., nursing staff and patients)—to better understand the anatomy involved in an abnormal finding or its normal equivalent, visualization software is provided to look at specific structures in various planes of their choice. The function provides full detail for volumetric studies and uses the imaging atlas as context for cross-sectional studies.

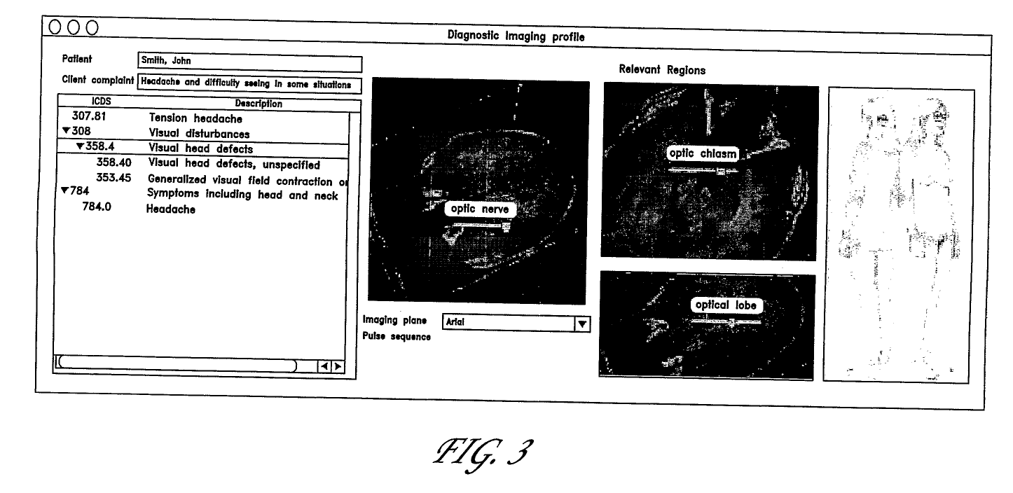

The diagnostic imaging profile produced by the anatomy knowledge base comprises a ranked list of imaging sequences, including sequence type, condition, and orientation, an illustrative example of which is shown in FIG. 3.

The profile's associated structures and findings can be linked to the structural map of the anatomy knowledge base, specifically its spatial section. As described below, the system represents spatial relationships among anatomical structures by grounding them against appropriately selected image volumes, associating each structure with a single vertex that can be interpreted as the centroid of that structure within the designated image volume. By retrieving these grounding images and their vertices, profile visualization can present the anatomical structures related to a given patient presentation in terms of a graphical map of the human body.

Co-occurrence analysis of NLP output can be performed to provide corpus-based answers to the questions “what does the patient mean” for task (1), “where to look” in an imaging study for task (2), and “how to look” at the patient for task (3). For tasks (2) and (3), the term category is based on the standardized and normalized location/symptom expression that is the output of task (1). Task (2) combines this with the medical conditions provided by the physician hypothesis. The selection of relevant anatomical structures is determined by measuring associations among terms present in patient presentation and physician hypotheses with terms of anatomical structures present in the knowledge base.

Associations of symptoms, conditions and structures (structural/functional map) and the associations of anatomical structures with imaging diagnostics (diagnostic imaging map) can be formed automatically on the basis of their mutual co-occurrences in medical reports. The assumption is that the more frequently symptoms and anatomical structures appear together in individual documents in a corpus of medical records (or passages of a document), the greater the inferential power we have in determining the certain medical conditions are associated with specific anatomical structures. The same holds for the co-occurrence of anatomical structures and imaging diagnostics.

The system can determine co-occurrences among these feature types using a document-term matrix. An individual document is represented as a vector of terms drawn from the document-term matrix. The similarity between any two documents can be measured by the cosine coefficient, which essentially measures the amount of terminological overlap between the two documents. Such document-document similarities can be used to generate clusters of related documents, and even more usefully, to measure the similarity between a user query and a document, providing a rank-ordered set of documents that are most similar to the query.

The system can use the document-term matrix to measure associations among terms rather than documents. The document axis of the matrix can be the set of medical reports. The term axis is the set of NLP-generated classified terms that is the output of task (1). Each term is represented as a vector of document identifiers, and the associations of terms are then measured using the cosine coefficient. Thus, for a given symptom, the system can generate a list of anatomical structures most closely associated with the symptom. Two features are related if they co-occur more frequently than predicted by random distribution. Initially, this can be expressed as: C=(symptom AND structure)/(symptom OR structure) where “symptom AND structure” is the number of records that mention both a given symptom and anatomical structure (perhaps within a given passage), and “symptom OR structure” is the number of records in which either appear. A given symptom can be associated with a structure for values of C that exceed a certain threshold, using the actual value of C to rank the strength of the associations. Furthermore, the expression for C can assume that all documents and terms cany equal weight in the document-term matrix, and that associations are measured using simple document counts. In an illustrative example, a normalized set of associations was constructed among 1,320 genitourinary anatomical locations and functions. Corresponding expert-generated associations for the neuro and musculoskeletal domains can be used to empirically determine appropriate thresholds for establishing co-occurrences in the knowledge base. These co-occurrences can be used as standalone correlators or as input to other correlation methodologies.

In conjunction with co-occurrence analysis, the system can use statistical analysis of the NLP output (the tagged master list of terms) to automatically define, for a new patient presentation, (1) a standardized expression of that patient presentation, (2) the relevant anatomical structures for that presentation, and (3) the appropriate imaging sequence that best visualizes these anatomical structures.

The output of NLP content extraction is a structured and tagged master list of terms that belong in one of four broad categories: (a) patient presentation (normalized to locations and symptoms), (b) physician hypothesis (medical condition), (c) findings including anatomical structures containing abnormality or documenting normalcy, and (d) imaging sequence attributes. Additional features that will be included in the statistical analysis are derived from patient demographic information (e.g., age, sex). The operations (described below) used to cluster the training set and label new patient data are; feature selection, clustering of the training data, and classification of new patients.

The number of features can be relatively large (e.g., presenting symptoms for a chief complaint of “knee pain” can have several features: “laterality of pain,” “severity of pain,” “pain frequency,” “pain radiation patterns”, etc.). The system can, for example, use a subset or all of the features that are captured in most of the patient records and perform stepwise linear discriminant analysis to determine the independent importance of each feature in clustering the data. Since the entire feature set can not be available for all the patients, a team of domain experts can determine which features can be missing from a patient presentation for that presentation to be included in the analysis.

The system can use the classification tree approach in Classification and Regression Trees (CART) to partition the data into clusters of abnormalities in different anatomical structures. In an example, CART is chosen based on its known, successful use in data mining applications. Each cluster will then define a feature space of patient presentation that resulted in an abnormality in a specified anatomical region.

Incoming patient presentations can be structured and standardized by the same procedure as the training set data. The data is then classified as belonging to one of the clusters in the training set using CART analysis.

In one embodiment, the system can automatically locate relevant anatomical structures in the appropriate imaging sequences within a patient imaging study.

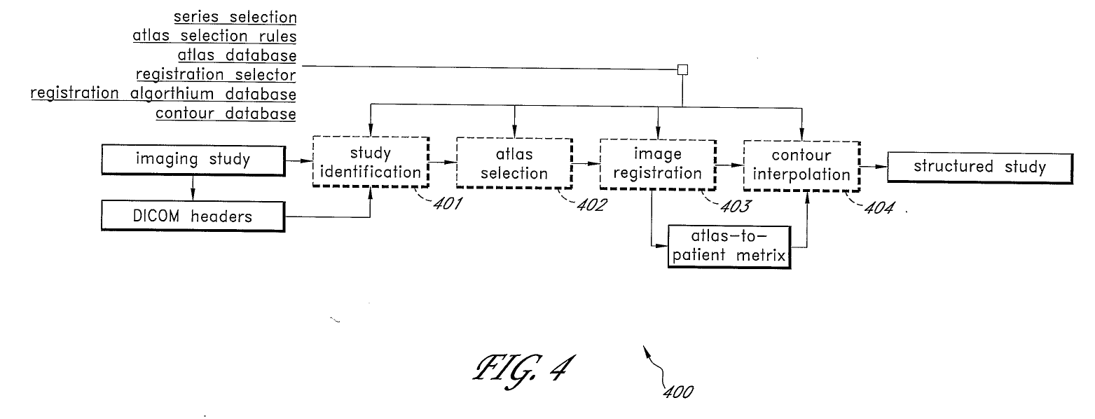

In the system, the image router can be configured with an additional XML rule that sends studies to the anatomical structure delineator. Anatomical structure delineation is accomplished through a multi-layer algorithm that includes; study identification, atlas selection, image registration, and contour interpolation. Anatomical structures delineated by this subsystem are then filtered for relevance based on the output of the anatomy knowledge base. FIG. 4 is a block diagram of the anatomical structure delineation module 400. In the anatomical structure delineation module 400, imaging study data and DICOM headers are provided to a study identification module 401. Data from the study identification module 401 is provided to an atlas selection module. Results from the atlas selection module 402 are provided to an image registration module 403. An atlas-to-patient matrix and other data from the image registration module 403 are provided to a contour interpolation module 404. The structured study is provided as an output of the contour interpolation module 404. Series selection rules, atlas selection rules, the atlas database, registration selector data, a registration algorithm database, and a contour database are provided to the structure delineation module 400.

The study identifier module 401 reads and parses the DICOM (Digital Imaging and Communications in Medicine) image header. The DICOM standard specifies a non-proprietary data-interchange format and transfer protocol for biomedical images, waveforms, and related information. Of particular interest are the data elements that describe: patient age (to select the appropriate age-specific atlas); anatomic region (to confirm that the image of an anatomy is brain or knee related); imaging modality (to select the appropriate modality-specific atlas); imaging geometry (to customize the atlas to the patient image orientation and to identify the appropriate image series for registration to atlas); sequence type (e.g., spin echo, gradient recalled) and acquisition parameter values such as the TE and TR (to customize the atlas to the patient image contrast).

The atlas selector module 402 uses the study identifier information to: (1) select and/or customize the atlas, and (2) identify the most appropriate image series for registration using the criteria of maximum resolution and anatomy coverage. For example, the optimum brain atlas for a geriatric patient is an age-matched adult brain atlas. A table that maps relevant parameters of a patient to a given atlas will be created by experts and stored within a knowledge base. Within the knowledge base, a particular atlas will be described by meta-data including the age, anatomy, and imaging modality/orientation used to construct the atlas.

In one example embodiment, an illustrative probabilistic labeled brain atlas (from nine patients) is used, and the evaluation can be performed using studies that had the same acquisition parameters as the atlas and some that differed in the acquisition parameters. An illustrative evaluation showed that when the acquisition parameters are close, the probabilistic atlas provided accurate napping, and was relatively less accurate in studies with different image contrast/intensities. This is due to the fact that registration algorithms based on voxel signal intensity do not work as efficiently when image contrasts of patient and atlases are very different. In another example, probabilistic atlases are used with a range of image contrasts to match different MR acquisition schemes. As the goal of image summarization is localization to a slice level, rather than accurate object segmentation, a reference atlas (defined as an atlas based on a single subject) can be sufficient. The reference atlas can be contrast-customizable to increase the efficiency of the voxel intensity based registration algorithms.

The decision to create atlases with different contrasts arises from the requirements of the registration algorithms as well as the clinical use of a wide range of pulse sequences generating images with different tissue contrasts. An ideal atlas should have similar contrast and image intensity compared to a given patient. Most of the automated voxel registration algorithms are intensity-based and rely on the assumption that corresponding voxels in two compared volumes have equal intensity; this supposition is often referred to as the intensity conservation assumption. However, this assumption does not hold for MRI volumes acquired with different coils and/or pulse sequences. The image registration module can use three algorithms for image alignment: a moments based algorithm, an automated voxel intensity-based algorithm, and an optical-flow based non-linear algorithm (as shown, for example, in Non-Rigid Matching Using Demons, Image Matching As A Diffusion Process: An Analogy With Maxwell's Demons, Thirion J P., Med Imag Anal 2:243-260, 1998, hereby incorporated by reference); the last two are sensitive to the contrast and intensity differences between reference and target image volumes. Adaptive intensity matching between reference and target images can be used for the optical-flow based non-linear algorithm to align images with different contrasts (T1 to T2 etc.) (see, e.g., Three Dimensional Multimodal Brain Warping Using The Demon's Algorithm And Adaptive Intensity Correction, Guimond A, Roche A, Ayache N, et. al., IEEE Trans Medical Imaging. 20, 58-69, 2001, hereby incorporated by reference).

In one embodiment, the approach to handling datasets with different contrasts is to develop customizable atlases (e.g., atlases of the brain and of the knee) whose contrast and intensity can be matched to that of a target patient image set. In order to create the customizable atlases, MR parameter maps (T1, T2, and proton-density) are calculated from MR images acquired using pulse sequences (combination of saturation recovery and multi-echo sequences). The atlas customization to patient data is accomplished in two steps: contrast matching based on image synthesis, and intensity matching based on histogram matching.

Contrast matching is used to adjust image contrast. The system includes an MR image synthesis algorithm that allows new images to be synthesized at different values of the acquisition parameters (echo time TE, repetition time TR, and flip angle FA) and for different sequence types (spin echo, gradient echo, inversion recovery). In one embodiment, this can be extended to synthesize atlas data from the MR parameter maps acquired for the normal adult and pediatric subjects. The synthesis of an atlas matched to the patient scan parameters provides a contrast-matched reference data set to increase the accuracy of registration. In order to maintain the integrity of patient images, synthesis is typically performed on the atlas data rather than the patient data. The atlas synthesis can also be extended to include generation of diffusion models of the brain to correct for image distortions in diffusion echo planar images.

Intensity matching can be used to adjust for MR image intensity differences between the synthesized atlas and the patient dataset. Intensity standardization can be performed by matching the intensity histogram of the patient data to that of the synthesized atlas data by matching histograms.

Several options are available to establish an appropriate knee atlas for registration: (1) optimization of pulse sequence parameters for the parametric atlas creation (tuning for the T1 and T2 of the knee tissues); (2) evaluation of atlases created from images acquired in sagittal and axial images; (3) evaluation of atlases from images acquired with and without fat suppression. Synthesis of fat suppressed knee images has been investigated and depends on the pulse sequence used for fat suppression in the patient knee images: (i) fat suppressed images acquired with STIR (short-TI inversion recovery images) can be synthesized in a straightforward manner using the known signal intensity equation for STIR and the inversion time, T1, of the sequence (as shown, for example, in Magnetic Resonance Imaging, Physical Principles And Sequence Design, Haacke E M, Brown R W, Thompson M R, et. al., Chapter 17, Wiley-Liss, 1999, hereby incorporated by reference); (ii) synthesis of atlas images using fat-saturation pulses can be more difficult and can involve the labeling of fat pixels in the atlas.

The customizable atlases of the brain and the knee can be analyzed as a reference standard and, in the case of the brain studies, compared to the performance of the probabilistic atlas at fixed contrast (T1 weighted) that was used in preliminary studies. Probabilistic atlases can be more accurate for model-based segmentation of structures in patient images with similar contrast. The customizable atlases can be a practical method of matching to different image acquisition schemes, for example, in a clinical teleradiology setting.

The registration module 403 performs the registration of an atlas to the user image datasets; as such, the inputs into this module are an atlas from the atlas database and the user image datasets. The registration module 403 accesses an algorithm from the registration algorithms database and the rules pertaining to the registration procedure itself from the registration selection rules knowledge base.

The registration selection rules knowledge base provides the underlying logic for the automated selection of a registration algorithm, processing steps required prior to registration, and choice of registration parameters. The choice of the registration parameters can be based on published studies and/or empirically determined. For example, a double-echo knee sagittal image can require: (i) an affine transformation algorithm with outlier rejection to account for non overlapping volumes, and (ii) use of a modified cost function in the affine registration that uses information from both echoes.

The registration algorithms database includes three algorithms: a principal axis and moment based algorithm for a coarse alignment of axial datasets, a 3D voxel intensity-based global affine transformation algorithm, and a local deformation algorithm based on an optical flow model for higher order alignment of the image datasets. In an embodiment, known registration tools for brain and knee image datasets are optimized and rules are provided for determining the parameters of the registration algorithm for the current patient image study. The registration algorithms also accommodate the large range of clinical acquisitions: truncated coverage, low resolution (in-plane, slice thickness and or slice gaps), and large spatial displacements. The modifications to the algorithms include rejection of outlier pixels and global optimization techniques.

Implementations of the registration algorithms and the modifications for knee images are provided below.

The principal axes of an object are those orthogonal axes about which the moment-of-inertia is minimized. The eigenvalues and corresponding eigenvectors of the moment of inertia tensor of the two volumes are determined. A scaling factor is determined from the eigenvalues and the eigenvectors are used to calculate the rotation matrix to align one volume to the other (see e.g., Orientation Of 3D Structures In Medical Images, Faber T L, Stokely E M, IEEE Trans Pattern Analysis Mach. Intell., 10:626-633, 1988; Iterative Principal Axes Registration Method For Analysis Of MR-PET Brain Images, Dhawan A P, Arata L K, Levy A V, et. al. IEEE Trans BioMed Eng., both of which are hereby incorporated by reference). This provides a relatively coarse registration of the atlas to patient image data and is used to provide an initialization for the following more accurate (and computationally more expensive) registration algorithms.

Subsequent to the moment-based algorithm, a 3D voxel intensity based algorithm is applied to obtain the global affine transformation required to align the patient and reference datasets. This algorithm uses a cost function defined by the mean of the square of the differences of corresponding voxel intensities in the reference and target volumes to search the transformation space for the parameters that minimize this function (see, e.g., Automated Image Registration I and II, Woods R P, Grafton S T, et. al., J Comput. Assist Tomogr., 22:153-165, 1998, hereby incorporated by reference). A multivariate Marquardt-Levenburg minimization is used to search for the spatial transformation that registers the two image datasets. This algorithm uses the signal intensity match of equivalent pixels in the target and reference sets and the customizable atlas is an effective method to provide a contrast/intensity matched reference atlas for a wide range of patient data. It should be noted that this illustrative algorithm yields a global transformation and local deformations are not modeled.

The cost function is sensitive to contributions from voxels that do not have matching voxels in the second dataset. These are termed outliers and can be a significant number in sagittal and coronal orientations since the object is not entirely in the field of view. As a consequence of this, non-overlapping volumes will then give a large value for the cost function and an automated method for outlier identification is necessary. Least trimmed square optimization can be implemented to reject outliers (as shown, for example, in Robust Regression And Outlier Detection Probability And Mathematical Statistics, Rousseeuw P J, Leroy A., New York, Wiley, 1987, hereby incorporated by reference).

Segmentation of the bone from soft tissue followed by region based registration. This can be used in studies with fat-saturated sequences where the bone is relatively easier to segment.

Incorporation of the information from both image sets of a double-echo sequence in calculation of the cost function to increase registration robustness (double echo imaging is a routine clinical sequence for knee protocols).

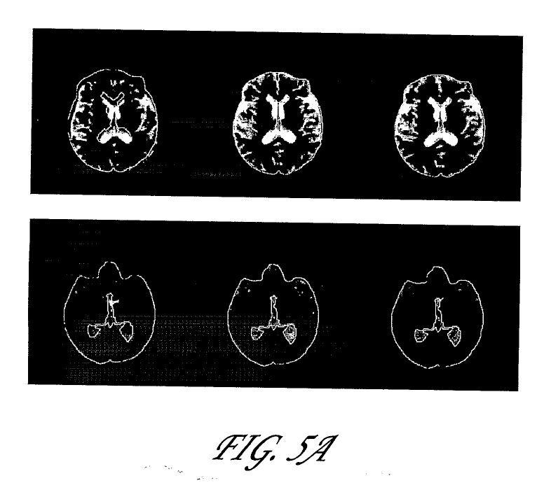

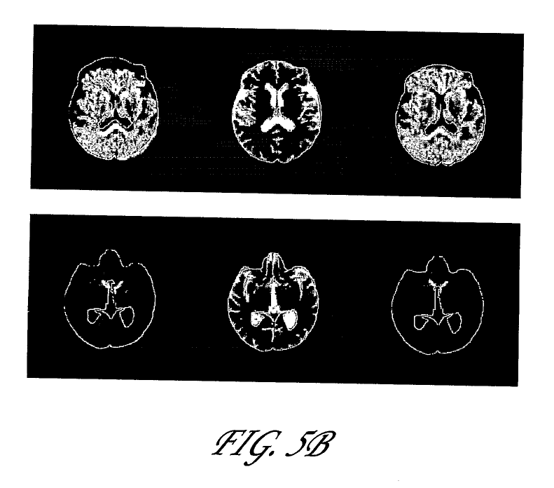

Subsequent to the moment-based algorithm, a 3D voxel intensity based algorithm is applied to obtain the global affine transformation used to align the patient and reference datasets. This is followed by a local free-form deformation based on the concept of demons (see, e.g., Thirion supra). The two volumes to be registered are considered as two time frames f and g, and under the hypothesis that the intensity of points in the images is preserved under motion, the local displacement field v that brings the two volumes into local correspondence is given by:

$$v = \frac{( g - f ) Δ f}{{( Δ f )}^{2} + {( g - f )}^{2}}$$

where g and fare the image intensities of corresponding voxels in the two image volumes g and f; and Δf is the image gradient of the image volume f. The registration is implemented in a hierarchical fashion, with the alignment first performed at the lowest resolution obtained by sub-sampling by a factor of 8. The deformation field is regularized using a Gaussian kernel with a variable standard deviation (e.g., 1 to 3 pixels). The success of this algorithm depends on similar image intensities and contrasts in the two volumes to be registered. The customizable atlas provides a way to generate the required contrast/intensity matched image datasets. This technique corrects the image distortions in echo planar diffusion weighted images which includes synthesis of a diffusion model from a segmented T2 spin echo image (as shown in FIGS. 5a and 5b).

FIG. 5a shows example diffusion weighted echo planar images (b=0 s/mm2) at two different levels (left and right panels) with superimposed contours from the anatomical images, before (left) and after (right) warping to the corresponding T2 weighted image (middle). The visual match of the contours superimposed on the warped images confirms that the local formation algorithm corrects for distortions.

FIG. 5b shows example diffusion weighted echo planar images (b 1000 s/mm2) at two different levels (left and right panels) with superimposed contours from the anatomical images, before (left) and after (right) warping to the corresponding T2 weighted image (middle). The corrected images show good alignment with the anatomical T2 images as confirmed by the superimposed contours.

In extending the non-linear deformation to knee images, the system can include incorporation of a term to adjust for large differences in the term (g-f) and/or non-linear registration of the segmented bone structure.

Incorporation of a term to control for large differences in the term (g-f) (see optical flow equation) which can inherently arise from voxels in one volume having no corresponding voxel in the other.

Non-linear registration of the segmented bone structure from the atlas and patient data and use of the regularization procedure to propagate the deformation to the soft tissue of the knee; this can then be followed by a local deformation for the soft tissue.

The registration module 403 produces a global transformation matrix (for moments and affine registration) or a deformation map (optical flow) that maps pixels of the target image set into locations in the reference image space.

The contour generator module 404 uses the output of the registration module 403, namely, a matrix that defines the spatial transformation (rotation, translation and scaling) between the user image datasets and image atlas space (for moments and affine registration). This matrix is used to estimate the slices containing the targeted structures in the patient images from contours of the structure defined in the atlas and stored in a brain model. Appropriate modifications can be incorporated if the optical-flow algorithm is used, since the output is no longer a global matrix but a deformation field at each voxel.

The contour generator module 404 locates structures in other image series of the study, besides the series that was used in the registration. This is possible because the DICOM header provides the following information: (i) location of the top left voxel in any imaging study in magnet axes co-ordinates and (ii) the orientation of the row and column of each imaging volume with respect to the magnet axes. This information, along with the voxel resolution, can be used to generate the spatial transformation required to locate structures in other image series of the study.

For the illustrative image summarizer 108: (1) relevant anatomical structures are chosen based on the patient presentation and physician hypothesis, (2) an imaging study is performed with the guidance or assistance of the diagnostic imaging profile, and (3) this imaging study is mapped to a customized, labeled atlas to delineate its known anatomical structures. What remains at this point is to intersect the structures selected by (1) with those delineated in (3). This output is the summarized image study, including the images in the relevant image series that contain the relevant regions of interest.

The ideal case for image summarization occurs when there is an unambiguous match between the relevant structures and the delineated ones. Thus, summarization is a straightforward process of forming the union of slices occupied by the contours of the selected structures. However, due to the divergent sources of the customized image atlas (expert-tagged) and the anatomy knowledge base's structural map (report corpus), a one-to-one correspondence of structures is not a foregone conclusion.

This potential impedance mismatch can be addressed by using synonym maps which associate corpus-generated terms with other self-contained term sets. In this specific case, synonym maps can be used for both the neuro and musculoskeletal customized image atlases. Synonym maps can also be used to link the knowledge base to standardized terminologies, such as ACR, SNOMED-CT, or CDE.

Once complete, image summarization effectively filters an imaging study containing a large number of images (e.g., 150-250 images) to a much smaller but still relevant subset (e.g., 6-9 relevant images), thus, significantly reducing the bandwidth used when exchanging medical communication data as well as creating a simplified information package that can be easily assimilated by non-specialists such as primary care physicians or perhaps the patients themselves.

Three sets of information are available at the end of the image summarization process: (1) the clinical context of the study (patient presentation, physician hypothesis, and prior studies), (2) the complete set of contours, regardless of relevance, for all anatomical structures in the current patient's study, and (3) the subset of slices within that study that have been determined to be relevant, thus serving as the summary for that study. Item (3) can be significantly smaller than the raw study in its entirety, and can thus be sent feasibly to secure repositories over the Internet.

The DICOM standard can be used for storing and sharing this package of information. The DICOM data model, ranging from its basic headers to presentation state, can be used to represent all three sets of data. Adherence to this standard maximizes the shareability of this information beyond just the software developed by this project. In addition, the relatively small size of these data sets permits a single overall server to contain a significant number of DICOM files encoded with this information.

Communication with this repository can be encrypted as they are expected to be available over the Internet. Access to the database can be provided using a customized universal resource identifier (URI), facilitating one-click, Web-like behavior (once sufficient authorization has been provided). The output of this URI is a DICOM-compliant file that contains clinical context, contours, and key image slices for a specific case.

Scalability for the DICOM repository is handled by placing multiple servers “behind” a DataServer master index. The index routes overall queries to the correct physical server while continuing to present a unified logical repository to users. Deployment through DataServer results in the ability to view a patient's complete summarized record using the TimeLine interface.

Thus, in the system 100:
1. Patient presentation can be electronically captured and mapped to a standard nomenclature;
2. Patient presentation and physician hypothesis can be used to produce the list of relevant anatomical structures for the current case;
3. Upon study acquisition, known anatomical structures can be delineated;
4. Relevant structures and delineated contours can be combined to produce a relevance-driven summary of the patient's study;
5. The remote specialist can receive the summarized study and the entire data set as well as summaries of prior studies; and
6. The primary care physician can receive the results from both local and remote specialists along with summaries of the current study and prior studies.

To manage the storage and retrieval of the patient cohort's cumulative medical information, the system can incorporate previous work in medical data integration and visualization to provide a comprehensive, sununarized, time-based imaging view of a patient's history. The history viewer is Web-accessible, making it an ideal but familiar mechanism for remote specialists. The viewer integrates patient demographics as well as their firsthand presentation of the medical problem with summaries of prior studies, all generated using the technologies described in this proposal.

In other illustrative embodiments, the alternatives below can serve a dual role in that they can also be used for evaluating the researched technologies.

There are three potential points of failure in the knowledge base, corresponding to its three primary tasks: patient presentation normalization, relevant structure selection, and diagnostic imaging profile. If free-form patient presentations cannot be standardized or normalized sufficiently, the collection interface for this data can be re-expressed as a structured entry as opposed to free text. In the event that relevant anatomical structures are not satisfactorily identified based solely on patient presentation and physician hypothesis, this information can be manually forwarded to a human specialist who can directly select these structures. The forwarding mechanism can also be used during evaluation, as the human specialist serves as the gold standard for this process. Internal to the knowledge base, correlation algorithms that can yield better results than those discussed above can also be investigated and tested.

In one embodiment, the system can include functionality for wet reading based on DICOM presentation state to allow selection and annotation of key images by the local specialist. Moreover, studies can be stored in the DICOM presentation state and compared to the automatically generated summaries.

Evaluation of the system can be focused on testing the primary hypothesis that if a medical communication contains (1) automatically summarized imaging data, (2) accurately-recorded patient presentation, and (3) specific clinical questions, then (a) response time is better and (b) the quality of diagnosis is more accurate. Components of the proposed system can be evaluated from a technical perspective and/or tested in a clinical setting.

For convenience, the technical evaluation into three portions: (1) the accuracy of the corpus-based, NLP-guided knowledge base in the selection of relevant anatomical structures, (2) the effectiveness of the diagnostic imaging profile, and (3) the accuracy of anatomical structure delineation. All evaluations can be made against human experts using different data gathering techniques. A final, overall evaluation takes place for the endpoint of the proposed work, which is the accuracy of automatic image summarization. This overall evaluation is made against a summary produced by the local radiologist.

Knowledge base evaluation can occur at two levels: term associations (maps) and relevant structure selection. The first level evaluates the term association algorithm(s) that link various categories of terms (anatomical, functional, symptomatic, imaging) against other categories. The terms to include in the matrix can be selected according to frequency of occurrence within the corpus, thus prioritizing the most common presentations, anatomical regions, disease functions, and imaging sequences. Experts fill these tables with their own correlations. These correlations can be compared against the highest-probability correlations stored in the knowledge base using the standard recall and precision measures that are routinely used evaluations of information retrieval systems. Recall measures the proportion of expert-identified associations included in the knowledge base; precision measures the proportion of associations in the knowledge base that are identified by the experts. Recall and precision are inversely related. High levels of recall and precision together indicate a close match between the correlations of the knowledge base and the direct expertise of the human panel. When the terms involved relate to patient presentation, this evaluation measures the effectiveness of the knowledge base in standardizing or normalizing freeform patient presentations.

The second level of technical evaluation occurs by asking the same panel of experts to select, directly, the relevant structures of interest for a given patient presentation. The selected structures can then be compared with the structures produced by the inference engine of the knowledge base. High correlation between these two results can measure the accuracy of the structure selection.

The effect of having a visual diagnostic imaging profile available can be evaluated by comparing physicians who do and do not have access to such a profile. Specifically, physician hypotheses and imaging sequences between the two groups are compared. An expert panel determines, for each test patient presentation, what the best hypotheses and imaging sequences are without initially knowing the output of these two groups. Once the output from (a) the expert panel, (b) physicians without the diagnostic imaging profile, and (c) physicians with the diagnostic imaging profile are collected, a comparison can be made using the expert panel (a) as the gold standard. A stronger match between (a) and (c) than (a) and (b) indicates that the diagnostic imaging profile measurably benefits physicians in forming clinical hypotheses and specifying the most appropriate imaging tests for those hypotheses.

Independent validations can be performed for the registration algorithms and contrast customizable atlases within in this module. Validations can use simulated data as well as data from subjects; specifically validation can be for a wide range of images acquired from different clinical protocols, using established metrics for quantifying the accuracy of the algorithms. Overall evaluation can be performed by providing an expert panel with a selected set of imaging studies as well as a corresponding list of anatomical structures. The expert panel can be requested to draw their own delineation of the structures using a DICOM presentation state annotation tool. The contours saved by this tool can be compared against the contours produced by the automated structure delineation module. Assorted measures of geometric closeness, including Euclidean distance of centroid, overall volume, area per slice, slices spanned, and direct pixel differences can be used to evaluate the accuracy of the automated method.

For evaluation purposes, a manual summarization created by the local specialist serves as the standard against which the automated summary can be compared. The evaluation involves the following actions: Select a study set, perform automated selection of relevant slices, score results, analyze results, and assess results.

For example, in one example study set, 200 MR studies from a targeted patient population can be selected as the query image sets. Studies can be selected such that original patient presentation is available in some form.

The system performs an automated selection of the relevant images from the same 200 image studies, with the patient presentation provided as input.

The physician reviews the automatic image selections and assigns a score to each matching image, as well as state image slices that were missed entirely.

The physician scoring is analyzed using recall and precision measures, described in the evaluation of the knowledge base above. High levels of recall and precision indicate the ability of the experimental system in identifying relevant images for medical communication.

The inferential power of the sample is assessed, and includes more studies until an 80% confidence level with a 5% margin of error is achieved in the recall and precision results.

In one illustrative study population, the primary patient group of interest in the illustrative study included a well-defined population of 10,000 employees and family members of a large corporation. The patients received health insurance coverage from the corporation, a self-insured company with a network of participating providers and a dedicated primary care center adjacent to a comprehensive imaging facility. An MRI imaging facility was electronically connected to provide medical communication to local physicians. The focus is on two domains that have constituted the largest number of medical requests (i.e., musculoskeletal and neurology).

Comparison is made between two groups: (1) summarized studies and (2) full study sets. Both groups have access to patient presentation and initial primary care physician hypotheses. For Group 1 (status quo), a full set of the study is sent for consultation and prior studies are available, also as full datasets, by request from the consultant. The Group 2 consultant receives a summarized study as well as summarized prior studies that have been incorporated into an electronic medical record and accompany patient presentation and the initial physician hypotheses. For both groups, a researcher measures (a) the time required for reading each study; (b) how often the consultant accesses prior studies; and (c) total turnaround time.

Accuracy of these interpretations can be measured with a consensus group of physicians having access to both summarized and a full data set. Comparative statistical analysis is performed on these and begin with a stratified (neuro and musculoskeletal) randomization of 50 cases in each arm. The assessment of sample size in the trial comparing population mean times and diagnostic accuracy requires a variance estimate of the main efficacy variables (time, accuracy). Since this variance estimate has low precision at this developmental stage, it is appropriate to use the data from the first patient cases in an “internal pilot study” to estimate the sample size. A suitable method for this sample size determination can be used (see, e.g., A Method For Determining The Size Of Internal Pilot Studies, Sandvik L, Erikssen J, Mowinckel P, Rodland E A. Stat Med. 1996 Jul. 30; 15(14):1587-90, hereby incorporated by reference) which ensures that this sample size is adequate for the planned study.

In the illustrative example, the system can use existing data and data collected during routine care from real patients. Original data can be acquired for clinical indications. Information on patient subjects can be kept confidential by removing patient-specific identifiers and kept in secure locations/databases to respect patient confidentiality.

Information gathered in the process of evaluation from physicians is not de-identified, as the number of physicians participating in system evaluation can be too small to effectively maintain anonymity. Physicians, however, routinely participate in this kind of evaluation, and there are no questions related to their practice, social life, or any other personal issues. Although the system can have a positive impact on patients by improving medical communication efficiency and accuracy, these improvements can be the result of making appropriate data available to the physician.

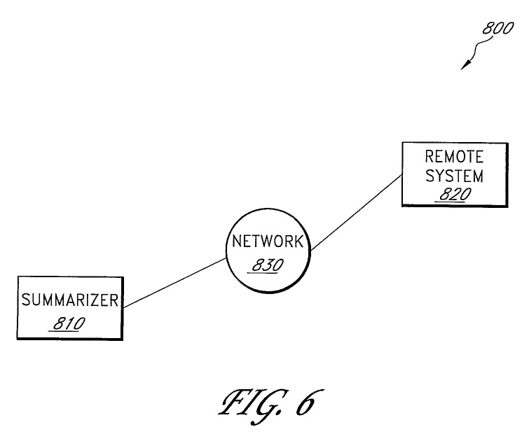

FIG. 6 is a block diagram of one embodiment of a data processing system 800 for context-sensitive telemedicine. The data processing system 800 includes a summarizer computer 810 that communicates with one or more remote computer systems 820 via a network 830. The network can be, for example, a local-area network, a wide-area network, or the Internet. The remote systems can be, for example, computer systems at specialists' locations.

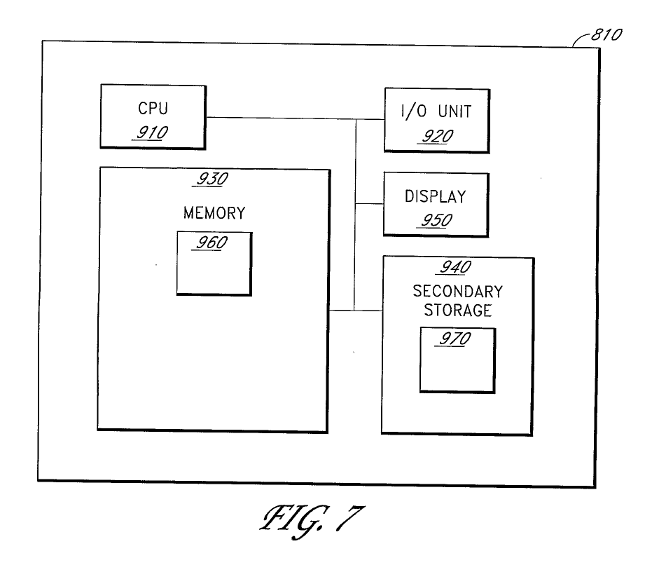

FIG. 7 shows the summarizer computer 810 of FIG. 6 in more detail. The summarizer computer 810 includes a central processing unit (CPU) 910, an input output I/O unit 920, a memory 930, a secondary storage device 940, and a video display 950. The summarizer 810 can further comprise standard input devices such as a keyboard, a mouse or a speech processing means (each not illustrated). One skilled in the art will appreciate that the system can be configured as a client-server environment. The programs and modules described above can be stored on a client computer system while some or all of the processing as described above can be carried out on the server computer system, which is accessed by the client computer system over the network. The memory 930 contains each of the computer programs and modules 960 described above. The databases and atlases can be stored, for example, in the secondary storage device 970.

The remote system can include components similar to those of the summarizer, including a central processing unit, an input output unit, a memory, a secondary storage device, a video display, and the programs and modules described above.

Although aspects of one implementation are depicted as being stored in memory, one skilled in the art will appreciate that data can be stored on or read from other computer readable media, such as, for example, secondary storage devices, like hard disks, floppy disks, and CDROM; a carrier wave received from a network such as the Internet; or other forms of ROM or RAM either currently known or later developed. Further, although specific components of the summarizer have been described, one skilled in the art will appreciate that a data processing system suitable for use with methods, systems, and articles of manufacture consistent with the present invention can contain additional or different components.

To overcome the problem of physicians and patients being required to filter large amounts of information obtained to study a patient's symptoms, the relevant medical information can be provided through an abstraction and summarization process. In this process, a normalized head atlas can be developed, for example, by comparing and summarizing head MRI of multiple normal subjects to obtain a normalized appearance of a subject head followed by labeling the head atlas with the relevant labels. Such relevant labels (e.g., terms which are common to medical communication among physicians, as opposed to termns which are shared by anatomists and largely unutilized by physicians) can be derived from data mining of head imaging reports using natural language processing methods, as described in the Examples herein.

A patient can then present to a physician indicating that he is having difficulty with his vision in both eyes. If a head MRI is conducted after the presentation, many image slices will be obtained, e.g., 150 slices, one or more of which will be more relevant to the patient's condition than others. The 150 slices can be mapped to the normalized head atlas described above and used to select the more relevant slices based upon the patient presentation, e.g., based on the findings described by a referring physician or original hypothesis (in this case, difficulty with vision in both eyes), anatomy terms and atlases, one, two or three image slices can be selected from the 150 slices, and provide the physician information regarding optic chiasm, a possible diagnosis for the patient. One of skill in the art will recognize that such a summarization or abstraction of image slices can be performed with other patient presentations, e.g., arterial damage, cartilage damage, bone injury, and other biological systems for which a normalized atlas can be provided.

Because the amount of medical information has been reduced, and the relevant medical information targeted to the patient presentation by the abstraction and summarization process described above, such relevant medical information is highlighted and its availability enhanced for other physicians and the patient.

The detailed description set-forth above is provided to aid those skilled in the art in practicing the present invention. However, the invention described and claimed herein is not to be limited in scope by the specific embodiments herein disclosed because these embodiments are intended as illustration of several aspects of the invention. For example, the described implementation includes software but the present implementation can be implemented as a combination of hardware and software or hardware alone. The invention can be implemented with both object-oriented and non-object-oriented programming systems. Any equivalent embodiments are intended to be within the scope of this invention. Indeed, various modifications of the invention in addition to those shown and described herein will become apparent to those skilled in the art from the foregoing description, which do not depart from the spirit or scope of the present inventive discovery. Such modifications are also intended to fall within the scope of the appended claims.

What is claimed is:

1. A method for processing context-sensitive patient data, the method comprising:
obtaining patient presentation data;
mapping the patient presentation data to biological system data, wherein the biological system data are obtained by a population-based comparison; and
generating a relevance-driven summary.

2. A method according to claim 1, further comprising communicating the relevance-driven summary, wherein the relevance driven summary is tailored to a set of user-defined inputs.

3. A method in a data processing system for context-sensitive medical communication, the method comprising:
obtaining a patient presentation;
mapping the patient presentation to a standard nomenclature;
generating a list of relevant anatomical structures based on the patient presentation;
delineating known biological system anatomical structures;
generating a relevance-driven summary by combining relevant structures and delineated contours; and
transmitting the summary to a remote location via a network.

4. A computer-readable medium having a program that performs a method for context-sensitive medical communication, the method comprising:
obtaining a patient presentation;
mapping the patient presentation to a standard nomenclature;
generating a list of relevant anatomical structures based on the patient presentation;
delineating known anatomical structures;
generating a relevance-driven summary by combining relevant structures and delineated contours; and
transmitting the summary to a remote location via a network.

5. A data processing system comprising:
a memory having a program that obtains a patient presentation, maps the patient presentation to a standard nomenclature, generates a list of relevant anatomical structures based on the patient presentation, delineates known anatomical structures, generates a relevance-driven summary by combining relevant structures and delineated contours, and transmits the summary to a remote location via a network; and
a processing unit that runs the program.

6. A method for producing a normalized anatomical atlas, the method comprising:
comparing and summarizing image data of multiple normal subjects; and
labeling the summarized image data with labels derived from data mining of imaging reports using natural language processing.

7. An apparatus for context-sensitive patient data, the method comprising:
an imaging apparatus configured to obtain one or more images of a patient;
one or more first computers configured to map patient presentation data and said one or more images to biological system data obtained by a population-based comparison and generating a relevance-driven summary; and
at least one display system configured to display said relevance-driven summary for diagnostic use by a physician.

8. The apparatus of claim 7, wherein said one or more first computers are configured to generate said relevance-drive summary at least in part tailored to a set of user-defined inputs.

9. An apparatus for context-sensitive medical communication, comprising:
a first computer configured to obtain patient images;
one or more second computers configured to map patient presentation data to a standard nomenclature, generate a list of relevant anatomical structures based on the patient presentation, delineate one or more biological system anatomical structures in at least one of said patient images, and generating a relevance-driven summary by combining relevant structures and delineated contours; and
a display computer configured to receive said relevance-driven summary via a network and display at least a portion of said relevance-driven summary.

10. A method, comprising:
inputting patient presentation data into a computer;
using a natural language processing module to map said patient presentation data to a standard nomenclature;
generating a list of relevant anatomical structures based, at least in part, on data from said natural language processor;
delineating one or more of said relevant anatomical structures from one or more medical images;
delineating contours of at least one of said relevant anatomical structures;
generating a relevance-driven summary using, at least in part, said contours; and
transmitting said relevance-driven summary to a computer via a computer network.

11. The method of claim 10, wherein said natural language processing comprises:
section boundary detection;
sentence boundary detection;
lexical analysis;
phrase chunking; and
semantic interpretation.

12. The method of claim 10, further comprising selecting said one or more medical images from a collection of images by selecting a relevant image slice.

13. The method of claim 10, further comprising generating a structural map that correlates anatomical features according to at least one of containment, spatial adjacency and connectivity.

14. The method of claim 10, further comprising generating a symptom map that relates anatomical terms to one or more symptoms.

15. The method of claim 10, further comprising generating a condition map that relates anatomical terms to one or more medical conditions.

16. The method of claim 10, further comprising generating an imaging map that lists one or more images of an imaging sequence.

17. The method of claim 10, further comprising selecting said one or more images at least in part based on an image contrast.

18. The method of claim 10, further comprising contrast matching of one or more of said images.

19. The method of claim 10, further comprising intensity matching of one or more of said images.

20. The method of claim 10, further comprising registration of said one or more of said images with images from an atlas.

21. The method of claim 20, further comprising registration of said one or more of said images with images from an atlas according to selection rules in a knowledge base.

22. The method of claim 20, wherein said registration comprises registration by principal axis.

23. The method of claim 20, wherein said registration comprises computing a three-dimensional voxel intensity-based affine transformation.

24. The method of claim 20, wherein said registration comprises computing local deformation based on an optical flow model.
